(19) United States
(12) Patent Application Publication
(10) Pub. No.: US 2005/0074023 A1
(43) Pub. Date: Apr. 7, 2005

(54) Method for sending and delivering multicast pager messages

(76) Inventor: Rajendra Wall, Plano, TX (US)

Correspondence Address: National IP Rights Center, LLC;Suite 400, 550 Township Line Road, Blue Bell, PA, 19422, US

(21) Appl. No.: 10/679,957

(22) Filed: Oct. 6, 2003

(51) Int. Cl. H04J 3/26

(52) U.S. Cl. 370/432; 340/7.26; 340/7.46

(57) ABSTRACT

A method for sending and delivering multicast pager messages is disclosed. The method includes the step of creating a group of users comprising a plurality of members. The method further includes the steps of receiving a message from a sender to the group of users, determining if the sender is a member of the group of users, and transmitting the message to the plurality of members of the group of users if the sender is determined to be a member of the group of users.

### FIELD OF THE INVENTION

The present invention relates to sending and receiving pager messages, and in particular to sending and receiving multicast pager messages to and from multiple pagers.

### BACKGROUND OF THE INVENTION

Currently a two-way pager (for example, the Motorola T900) can send another single pager a message, or, can send to more than one pager by explicitly listing each destination (some pagers need to send a separate message for each recipient). When such a pager receives a page that has been sent to multiple pagers, a reply can only be sent to the original sender. There is currently no way to reply to such a multicast message with another multicast message. (This is a limitation of text messages on cell phones as well) The best current work-around is to reserve a set of pager phone numbers—for example, a block from (xxx) yyy-1000 to (xxx) yyy-1100 for a companies employees—and then treat that block as if it were a private pager network, with each message that is sent to one pager being sent to every pager in the block.

If a pager in the block needed to be in more than one group at a time (for example, a doctor who worked at two different hospitals) then the pager had to be fitted with an additional hardware reception mechanism (called a CAPCODE) for each group.

U.S. Pat. No. 6,597,280 discloses a method for disseminating value-added information, starting from known radio paging services in which on one or more frequencies, by means of an address code which establishes the identity of a certain receiver, a message can be transmitted to the receiver, wherein at least one second standard address code is provided for identifying several receivers of the radio paging service, which is transmitted on one or more frequencies used by the radio paging service. By setting up a second address code, several subscribers to a radio paging service can be addressed simultaneously. The subscribers can in this case select and call up desired value-added information.

U.S. Pat. No. 6,480,720 is directed to a method for contacting a wireless user who subscribes to several bearer services. The wireless user may be active on only a single bearer service at any given time. The present invention discloses a method for contacting the wireless user by sending alert messages over each of the wireless bearer services in turn until the user is contacted.

U.S. Pat. No. 5,345,599 is directed to a method and apparatus for increasing the capacity of wireless broadcast communications system from a central studio to a plurality of users in a service area is disclosed. Given a source signal whose high information rate exceeds the practical information carrying capacity of the available broadcast channel bandwidth, the invention increases the effective capacity of the broadcast system to effectively communicate such a source signal. The high-rate signal is split into several low-rate signals such that each can be accommodated within the allocated bandwidth. These low-rate signals are transmitted from spatially separated transmitters, all radiating into the service area in the same frequency channel. Each receiver uses a plurality of antennas to receive these multiple cochannel signals that arrive from different directions-of-arrival. The receiver exploits the directions-of-arrival differences of these cochannel signals to separate them into the individually transmitted signals. The separated signals are then demodulated to extract the information signals which are then combined to obtain the original high-rate source signal. Thus, the broadcast information capacity can be increased several-fold.

There is a need, however, for a paging method that uses software to capture and redistribute the message allowing a pager to send a message to a named group without having to know the individuals in that group. The software also allows a pager to be in more than one group at a time, and to reply to the entire group when a group page is received.

### OBJECTS AND SUMMARY OF THE INVENTION

It is an object of the present invention to provide a method for sending and delivering multicast pager messages to a plurality of members of a group.

It is a further object of the present invention to provide a method for sending and delivering multicast pager messages to a plurality of members of a group and determining if the sender is a member of the group of users.

It is yet a further object of the present invention to provide a method for sending and delivering multicast pager messages to a plurality of members of a group and allowing a receiving member to reply back to the plurality of members of the group.

In accordance with a first aspect of the present invention, a novel method of sending and delivering multicast pager messages to a plurality of members of a group is provided. The method includes the steps of creating a group of users comprising a plurality of members, receiving a message from a member of the group of users, and transmitting the message to the plurality of members of the group of users.

In accordance with another aspect of the present invention, a novel method for sending and delivering multicast pager messages to a plurality of members of a group and determining if the sender is a member of the group of users is provided. The method includes the steps of creating a group of users comprising a plurality of members, receiving a message from a sender to the group of users, determining if the sender is a member of the group of users, and transmitting the message to the plurality of members of the group of users if the sender is determined to be a member of the group of users.

In accordance with yet another aspect of the present invention, a novel method for sending and delivering multicast pager messages to a plurality of members of a group and allowing a receiving member to reply back to the plurality of members of the group is provided. The method includes the steps of creating a group of users comprising a plurality of members, receiving a message from a sender to the group of users, determining if the sender is a member of the group of users, transmitting the message to the plurality of members of the group of users if the sender is determined to be a member of the group of users, receiving a reply message from another sender to the group of users, and transmitting the reply message to the plurality of members of the group of users if the sender is determined to be a member of the group of users.

### BRIEF DESCRIPTION OF THE DRAWINGS

The foregoing summary, as well as the following detailed description of a preferred embodiment of the present invention will be better understood when read with reference to the appended drawings, wherein:

FIG. 1 is a schematic representation of a multicast paging system in accordance with the present invention.

FIG. 2 is a flow diagram of a method of sending and delivering a multicast page to a group of members.

FIG. 3 is a flow diagram of a method of sending a message to another member of the group.

FIG. 4 is a flow diagram of a method of sending a message to an existing group and receiving a reply.

### DETAILED DESCRIPTION OF THE PREFERRED EMBODIMENT

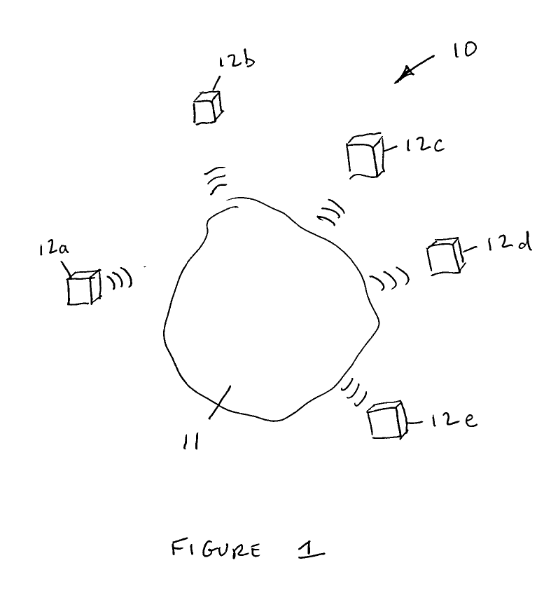

Referring now to the drawings, wherein like reference numerals refer to the same components across the several views and in particular to FIG. 1, there is shown a multicast paging system 10. The multicast paging system 10 includes a processing system 11, and a plurality of two-way pagers 12a, 12b, 12c, 12d, and 12e. The pagers 12a through 12e all together make up members of a user group.

In the embodiment illustrated in FIG. 1, the pager 12a is the multicast message sender. The pager 12a may be operated by the sender to send a multicast message to the members of the group of users, that is, the holders of pagers 12b through 12e. In general terms, the pager 12a sends a message to the processing system 11, which then delivers the multicast message to all the members of the group of users.

The administration of the group of users is primarily done through a Group Monitor (GM). For example, to create a group, a message is sent to the GM asking to create a new group. A group can either be public or private. In a public group, anyone in the community can find out about the group and post to it, whereas in a private group, only members of the group know about the group and can post to it.

Adding members to a group is accomplished by sending the GM a list of the individuals to be added as members to the group. The GM checks to see if the add message is from the group owner or creator. If the add message is from the group owner or creator, then the GM sends each individual, or nominee, a message notifying them of their nomination. Any names which the GM cannot find are returned to the original sender informing him that the names could not be found. If the message is not from the group owner or creator, then the GM sends a message to the group owner or creator notifying him that someone has requested to join the group. The group owner or creator can then approve all of the members of the group, some of the members, or none of the members. The GM may also include a directive that if a response is not received from the group owner or creator within a pre-determined period of time, 24 hours in a preferred embodiment, that all nominated members will be excluded from the group, and send the nominated members a message to that effect. The GM will send a message out to all approved nominated members notifying them of their nomination for membership in the group, the group's purpose, and a request for a “yes” or “no” response from the nominated member on joining the group. If the GM does not receive a “yes” reply within a predetermined period of time from the nominated member, 24 hours in a preferred embodiment, then the GM will consider the reply to be a “no” and exclude that nominated member from the group.

The group owner or creator may also have members removed from a group by sending the GM a message directing him to remove the members. If the GM verifies that the message was sent from the group owner or creator, then the GM will remove the members and send the removed members a notice that they have been removed from the group. A request from someone who is not the group owner or creator is returned by the group monitor to the sender with a message that only the group owner or creator can remove members from the group.

A member of a group, however, may request to be removed from the group by sending a message to the GM requesting removal from the group. If the GM can verify that the requestor and the member are one and the same, then the GM will remove the member from the group.

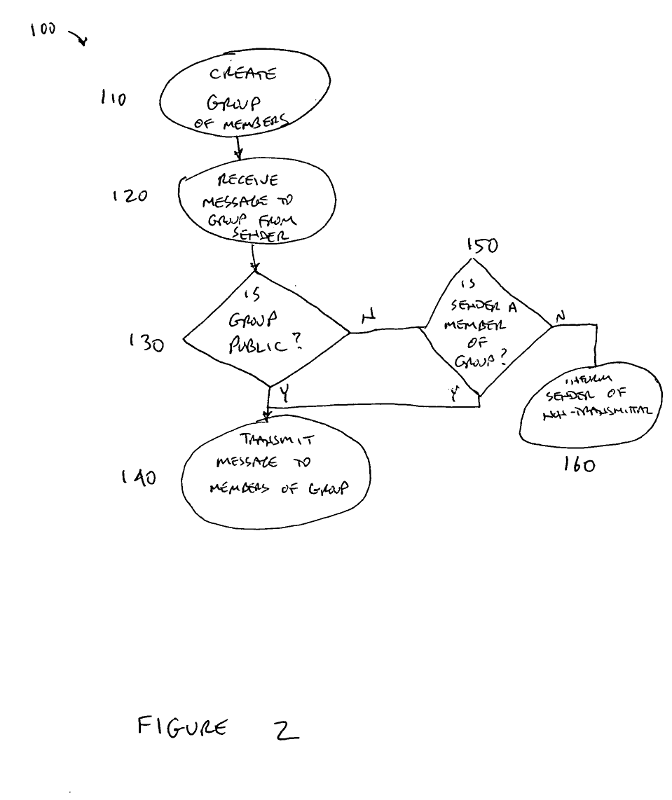

Referring now to FIG. 2, a flow diagram of the method of sending and delivering a multicast page is shown. The first step is to create a group of members 110. The system then receives a multicast message from a sender in step 120. In step 130, the processing system 11 then makes a first determination as to the group, that is, whether or not the group is public or private. If the group is public, then the processing system 11 delivers the message to the members of the group in step 140. If the group is private, then the processing system 11 has to make the additional determination in step 150 of whether or not the sender of the message is a member of the private group. If the sender is a member of the private group, then the processing system 11 delivers the message to the members of the group in step 140. If the sender is not a member of the private group, then the processing system 11 does not deliver the message to the private group, and proceeds to step 160, where it informs the sender that the message has not be sent because the sender is not a member of the private group.

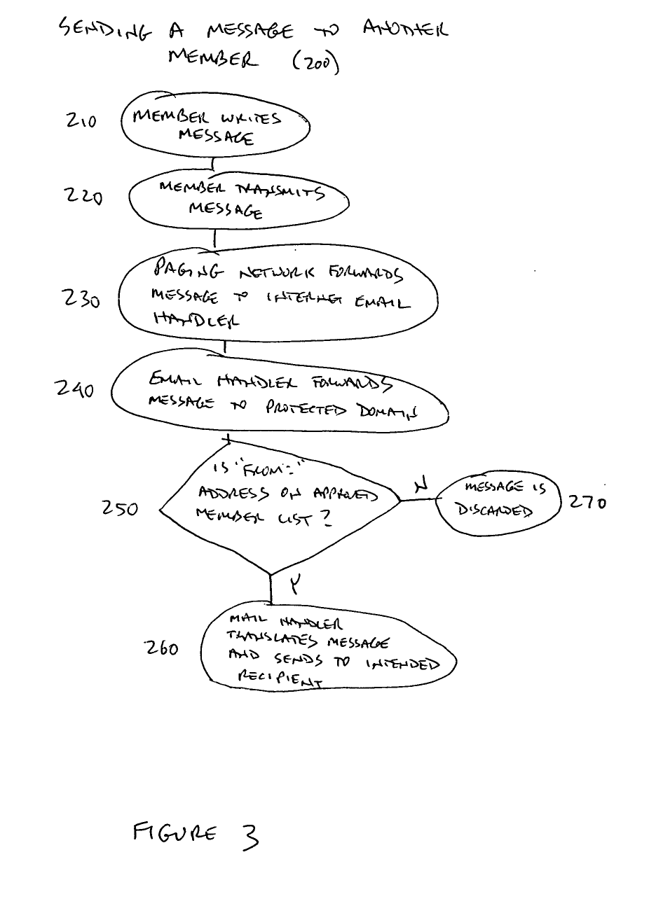

Referring now to FIG. 3, a flow diagram depicting sending a message to another member 200 is shown. The method begins with a member writing a message to another member using their two-way pager 210. This is followed by the member transmitting the message to another member 220. In step 230, the existing paging network forwards the message to the existing internet e-mail handler. The existing e-mail handler then forwards the message to the protected domain in step 240. In step 250, the inbound mail handler at the protected domain checks to validate that the sender of the message is on the list of approved members. If so, the outbound mail handler of the protected domain translates the outgoing “To:” field as per the information in the approved members list and delivers the message to the recipient in step 260. If the sender is not on the list of approved members, step 270 is performed, deleting the message.

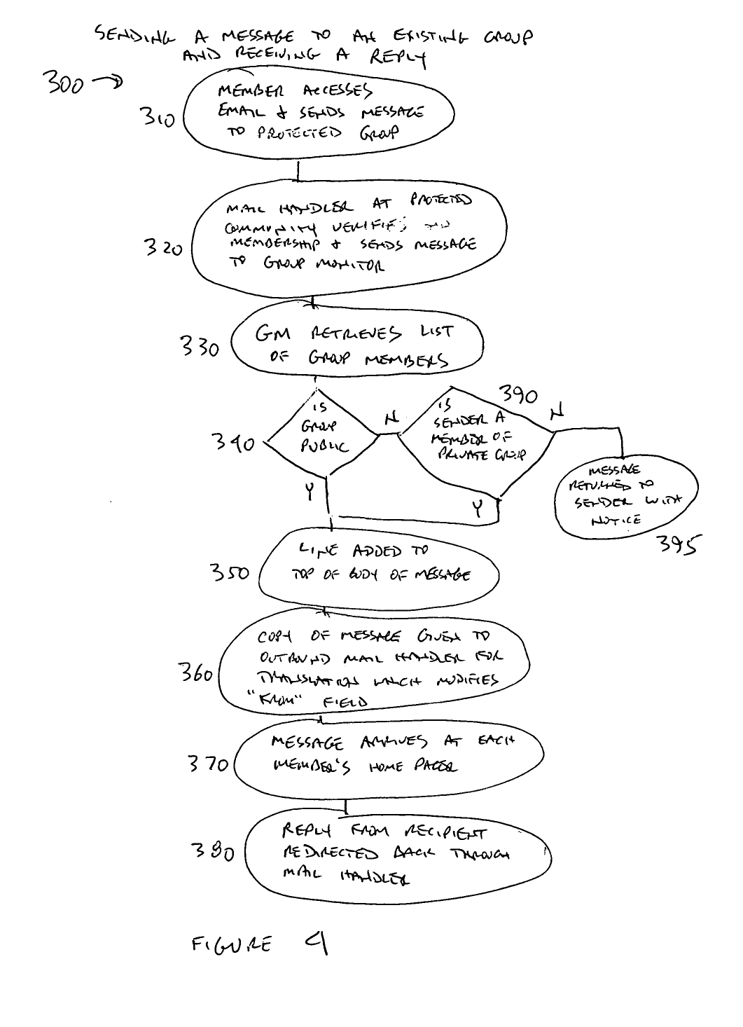

FIG. 4 depicts a detailed flow diagram for sending a message to an existing group and receiving a reply 300. In step 310, a member accesses his home email and sends a message to a group. The mail handler at the protected community verifies membership and hands the message to the Group Monitor (GM) in step 320. In step 330, the GM retrieves the list of members of the group. The group monitor then determines whether or not the group is public in step 340. If the group is not public then step 390 must be performed to determine if the sender is a member of the private group. If the sender is not a member of the private group, then the GM returns the message to the sender in step 395. If the sender is determined to be a member of the private group in step 390, or the group is determined to be a public group in step 340, then step 350 is performed, adding a line to the top of the body of the message with the sender's email address. In step 360, a copy of the message is given to the outbound mail handler for translation with the “From:” field now being the name of the group. The message is sent to each member's home pager as if it was from the group in step 370. Likewise, in step 380, any reply sent from a recipient is redirected back through the mail handler in the same way. If the group that the sender attempts to send the message to does not exist, the message is returned to the sender with that notice, and how to get help.

In view of the foregoing disclosure, some of the advantages of the present invention can be seen. For example, a novel method of sending and delivering multicast pager messages is disclosed. The method allows for a member of a user group to send a message to all the users in the group without having to know the actual member list. The method also allows for a reply message to be sent back from a recipient to the original sender and the rest of the members of the group in the same manner.

While the preferred embodiments of the present invention have been described and illustrated, modifications may be made by one of ordinary skill in the art without departing from the scope and spirit of the invention as defined in the appended claims.

1. A method for sending and delivering multicast pager messages, comprising the steps of:
creating a group of users comprising a plurality of members;
receiving a message from a member of the group of users; and
transmitting the message to the plurality of members of the group of users.

2. A method for sending and delivering multicast pager messages, comprising the steps of:
creating a group of users comprising a plurality of members;
receiving a message from a sender to the group of users;
determining if the sender is a member of the group of users; and
transmitting the message to the plurality of members of the group of users if the sender is determined to be a member of the group of users.

3. A method for sending and delivering multicast pager messages, comprising the steps of:
creating a group of users comprising a plurality of members;
receiving a message from a sender to the group of users;
determining if the sender is a member of the group of users;
transmitting the message to the plurality of members of the group of users if the sender is determined to be a member of the group of users;
receiving a reply message from another sender to the group of users; and
transmitting the reply message to the plurality of members of the group of users if the sender is determined to be a member of the group of users.

4. A method for sending and delivering multicast pager messages, comprising the steps of:
creating a public group;
allowing individuals to join the public group;
receiving a message from a member of the public group; and
delivering the message to all members of the public group.
